(19) United States
(12) Patent Application Publication
(10) Pub. No.: US 2018/0084124 A1
(43) Pub. Date: Mar. 22, 2018

(54) IMAGE PROCESSING APPARATUS AND NON-TRANSITORY COMPUTER READABLE MEDIUM

(71) Applicant: FUJI XEROX CO., LTD., Tokyo (JP)

(72) Inventor: Masatoshi MARUO, Kanagawa (JP)

(73) Assignee: FUJI XEROX CO., LTD., Tokyo (JP)

(21) Appl. No.: 15/497,875

(22) Filed: Apr. 26, 2017

(30) Foreign Application Priority Data
Sep. 21, 2016 (JP) 2016-184676

(51) Int. Cl. H04N 1/00; G06F 3/12

(52) U.S. Cl. CPC H04N 1/00411; H04N 1/00477; G06F 3/1268; G06F 3/1286; G06F 3/1238; G06F 3/1203; G06F 3/1236; G06F 3/1222

(57) ABSTRACT

An image forming apparatus includes a memory and a notification unit. On receipt of a print instruction operating in a first mode, the print instruction including a first setting value of a setting item for printing and a notification destination in a case where the first setting value is changed, the memory stores the first setting value and the notification destination included in the print instruction. On receipt of a print instruction operating in a second mode, the print instruction including a second setting value of the setting item for printing and user identification information, if the second setting value is a value that has been changed from the first setting value stored in the memory, the notification unit notifies the notification destination stored in the memory of the setting item changed from the first setting value and the user identification information.

### CROSS-REFERENCE TO RELATED APPLICATIONS

This application is based on and claims priority under 35 USC 119 from Japanese Patent Application No. 2016-184676 filed Sep. 21, 2016.

### BACKGROUND

### Technical Field

The present invention relates to an image processing apparatus and a non-transitory computer readable medium.

### SUMMARY

According to an aspect of the invention, there is provided an image forming apparatus including a memory and a notification unit. On receipt of a print instruction operating in a first mode, the print instruction including a first setting value of a setting item for printing and a notification destination in a case where the first setting value is changed, the memory stores the first setting value and the notification destination included in the print instruction. On receipt of a print instruction operating in a second mode, the print instruction including a second setting value of the setting item for printing and user identification information, if the second setting value is a value that has been changed from the first setting value stored in the memory, the notification unit notifies the notification destination stored in the memory of the setting item changed from the first setting value and the user identification information.

### BRIEF DESCRIPTION OF THE DRAWINGS

An exemplary embodiment of the present invention will be described in detail based on the following figures, wherein:

FIG. 1 is a diagram schematically illustrating an image forming system according to an exemplary embodiment of the present invention;

FIG. 2 is a block diagram schematically illustrating a terminal according to the exemplary embodiment of the present invention;

FIG. 3 is a block diagram schematically illustrating an image forming apparatus according to the exemplary embodiment of the present invention;

FIG. 4 is a flowchart illustrating an example of the operation of an installer according to the exemplary embodiment of the present invention;

FIG. 5 is a flowchart illustrating an example of the operation in an administrator mode of a printer driver according to the exemplary embodiment of the present invention;

FIG. 6 is an explanatory diagram illustrating an example of a display screen of a user interface (UI) when changing one or more default values and one or more print settings in the exemplary embodiment of the present invention;

FIG. 7 is a flowchart illustrating an example of the operation in a general mode of the printer driver according to the exemplary embodiment of the present invention;

FIG. 8 is an explanatory diagram illustrating an example of a display screen of the UI when changing one or more print settings in the exemplary embodiment of the present invention;

FIGS. 9A and 9B are explanatory diagrams illustrating examples of a print job in the exemplary embodiment of the present invention, including FIG. 9A illustrating the case in the administrator mode and FIG. 9B illustrating the case in the general mode;

FIG. 10 is a flowchart illustrating an example of the operation of the image forming apparatus according to the exemplary embodiment of the present invention; and

FIG. 11 is an explanatory diagram illustrating an example of email notifying a change notification destination of the details of a change when the default value is changed.

### DETAILED DESCRIPTION

### Exemplary Embodiment

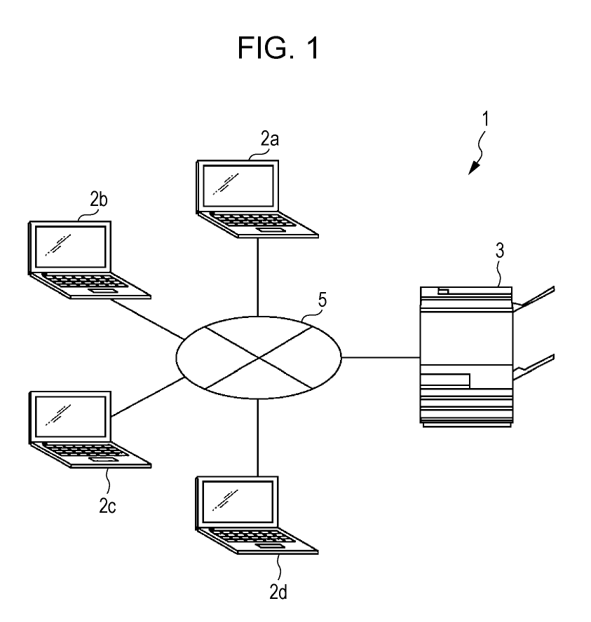

FIG. 1 is a diagram schematically illustrating an image forming system according to an exemplary embodiment of the present invention. As illustrated in FIG. 1, an image forming system 1, serving as an example of the exemplary embodiment, includes multiple terminals 2a, 2b, . . . , and 2d, and an image forming apparatus 3, which are connected by a network 5.

The terminals 2a, 2b, . . . , and 2d are personal computers (PCs), for example. The terminal 2a is used by an administrator, and the other terminals 2b, . . . , and 2d are used by general users.

### Configuration of Terminal

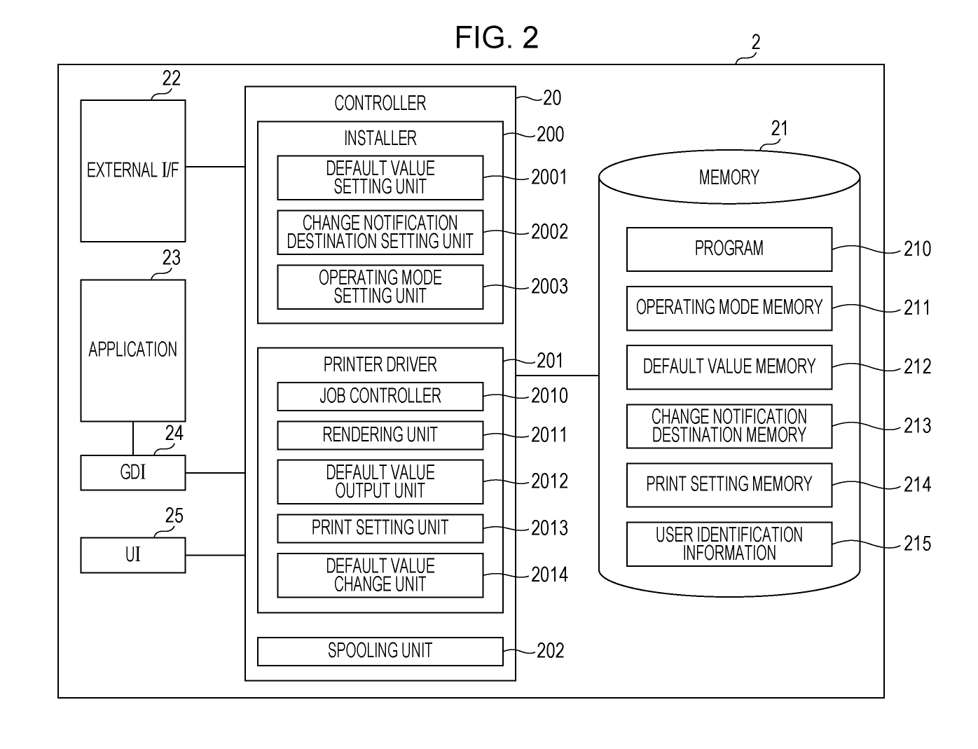

FIG. 2 is a block diagram schematically illustrating each terminal according to the exemplary embodiment of the present invention. In FIG. 2, the terminals 2a, 2b, . . . , and 2d illustrated in FIG. 1 are represented by one terminal 2.

As illustrated in FIG. 2, the terminal 2 includes a controller 20, a memory 21, an external interface (external I/F) 22, an application 23, a graphic device interface (GDI) 24, and a user interface (UI) 25.

The controller 20 includes a central processing unit (CPU), controls each component, and executes various programs. The controller 20 includes an installer 200, a printer driver 201, and a spooling unit 202.

The installer 200 installs the printer driver 201 on the terminal 2. The installer 200 includes a default value setting unit 2001, a change notification destination setting unit 2002, and an operating mode setting unit 2003.

The printer driver 201 provides a printing process or a process of the UI 25 in response to an instruction from the GDI 24. The printer driver 201 includes a job controller 2010, a rendering unit 2011, a default value output unit 2012, a print setting unit 2013, and a default value change unit 2014.

The memory 21 includes a recording medium such as a hard disk and a flash memory, and stores various items of information. The memory 21 includes a program 210, an operating mode memory 211, a default value memory 212, a change notification destination memory 213, a print setting memory 214, and user identification information 215.

The external I/F 22 performs communication with the image forming apparatus 3 or other external devices through the network 5. The application 23 generates image data to be printed, and the GDI 24 receives a rendering instruction from the application 23 or a setting from the user. The UI 25 includes a touchscreen, for example, and is an operation-and-display unit including an operation unit and a display.

The default value setting unit 2001 sets, in the printer driver 201, various default values regarding setting items for printing, when the installer 200 installs the printer driver 201 on the terminal 2.

When one of the set default values is changed, the change notification destination setting unit 2002 sets the email address of a notification destination to which a notification of the details of the change is to be sent.

The operating mode setting unit 2003 sets one of an administrator mode, which is a first mode, and a general mode, which is a second mode, for the to-be-installed printer driver 201 to operate. Hereinafter, the first mode will be referred to as the administrator mode, and the second mode will be referred to as the general mode. The operating mode setting unit 2003 corresponds to a setting unit that sets one of the first mode and the second mode as an operating mode.

The job controller 2010 controls a print instruction received from the GDI 24. The rendering unit 2011 converts the print instruction, received by the job controller 2010, to print data such as data in a page description language (PDL) or bit map data in accordance with information set by the print setting unit 2013.

The default value output unit 2012 outputs a print instruction including, when the operating mode of the printer driver 201 is the administrator mode, information indicating that the operating mode is the administrator mode, the default values, and, when any of the default values is changed, a notification destination to which a notification of the details of the change is to be sent; and when the operating mode is the general mode, the default value output unit 2012 outputs a print instruction including information indicating that the operating mode is the general mode, the default values, and the user identification information.

That is, the default value output unit 2012 corresponds to an output unit that outputs, when the operating mode is the administrator mode, which is the first mode, a print instruction including default values set by the administrator, and, when any of the default values is changed, a notification destination to which a notification of the details of the change is to be sent, and outputs, when the operating mode is the general mode, which is the second mode, a print instruction including default values set by the user and the user identification information.

The print setting unit 2013 performs the setup regarding printing. The default value change unit 2014 receives a change of one or more default values, and sets the changed default value(s).

The program 210 stored in the memory 21 causes the controller 20 to function as the above-mentioned units 2001 to 2003 and 2010 to 2014. That is, the program 210 is a program causing the controller 20 of the terminal 2 to function as the operating mode setting unit 2003, which sets one of the administrator mode and the general mode as the operating mode, and the default value output unit 2012, which outputs, when the operating mode is the administrator mode, a print instruction including the default values of setting items for printing, which are first setting values set by the administrator, and, when any of the default values is changed, a notification destination to which a notification of the details of the change is to be sent, and outputs, when the operating mode is the general mode, a print instruction including the default values of setting items for printing, which are second setting values set by the user, and the user identification information.

In this manner, the term “first setting value” corresponds to a default value of a setting item for printing, set by the administrator when the operating mode is the administrator mode, and the term “second setting value” corresponds to a default value of a setting item for printing, set by the user when the operating mode is the general mode.

The operating mode memory 211 stores the operating mode of the printer driver 201, set by the operating mode setting unit 2003. The default value memory 212 stores one or more default values changed by the default value change unit 2014.

The change notification destination memory 213 stores a change notification destination set by the change notification destination setting unit 2002. The print setting memory 214 stores the print settings set by the print setting unit 2013. The user identification information 215 is stored as information for identifying a user who has changed one or more default values in the general mode.

### Configuration of Image Forming Apparatus

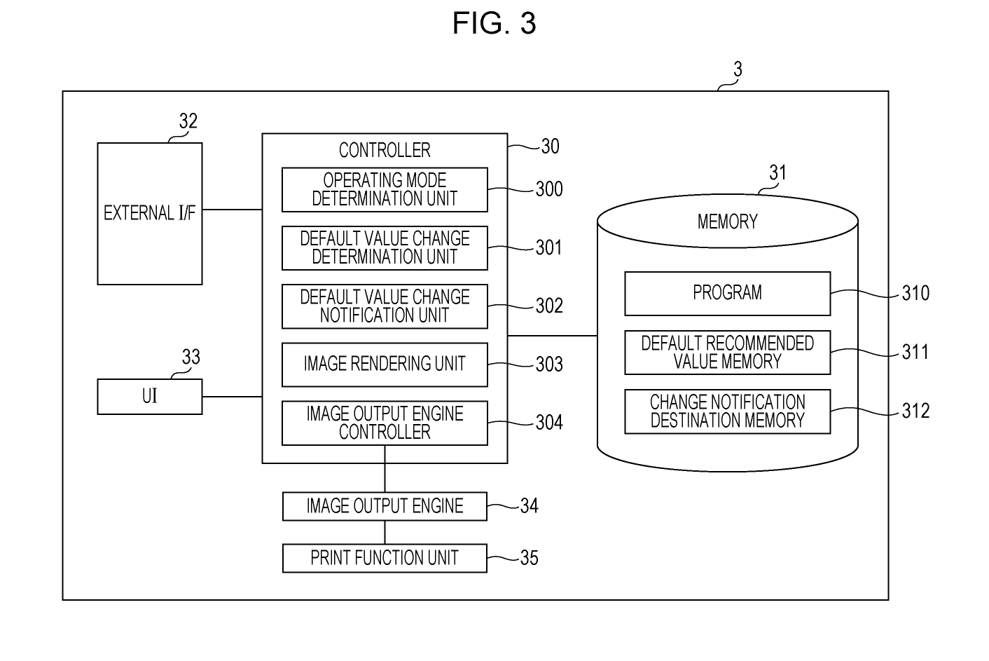

FIG. 3 is a block diagram schematically illustrating the image forming apparatus according to the exemplary embodiment of the present invention. As illustrated in FIG. 3, the image forming apparatus 3 includes a controller 30, a memory 31, an external interface (I/F) 32, a user interface (UI) 33, an image output engine 34, and a print function unit 35.

The controller 30 includes a CPU, controls each component, and executes various programs. The controller 30 includes an operating mode determination unit 300, a default value change determination unit 301, a default value change notification unit 302, an image rendering unit 303, and an image output engine controller 304.

The memory 31 includes a recording medium such as a hard disk and a flash memory, and stores information. The memory 31 includes a program 310, a default recommended value memory 311, and a change notification destination memory 312.

The operating mode determination unit 300 determines which of the administrator mode and the general mode the operating mode of a received print instruction is.

The default value change determination unit 301 compares the default values included in a received print instruction when the print instruction is in the general mode with the default values included in a print instruction in the administrator mode, and determines whether there is any difference between the two sets of default values, that is, whether any of the default values has been changed.

When any of the default values has been changed, the default value change notification unit 302 notifies a change notification destination stored in the change notification destination memory 213 of the details of the change of the default value(s) and the user information.

The image rendering unit 303 renders image data that the print function unit 35 is capable of printing in accordance with the print instruction. The image output engine controller 304 controls the image output engine 34 in order to print the image data rendered by the image rendering unit 303 using the image output engine 34.

The program 310 stored in the memory 31 causes the controller 30 to function as the above-mentioned units 300 to 304. In particular, on receipt of a print instruction operating in the general mode, which includes the default values set by a general user for setting items for printing and the user identification information, if any of the default values has been changed from the default values stored in the memory 31 and set by the administrator, the program 310 causes the controller 30 of the image forming apparatus 3 to function as the default value change notification unit 302, which notifies a notification destination stored in the memory 31 of the changed details and the user identification information.

On receipt of a print instruction operating in the administrator mode, which includes the default values set by the administrator for setting items for printing and a notification destination when any of the default values is changed, the default recommended value memory 311 stores the default values included in the print instruction and set by the administrator. Similarly on receipt of a print instruction operating in the administrator mode, the change notification destination memory 312 stores a notification destination included in the print instruction.

As described above, the image forming apparatus 3 includes the memory 31 including the default recommended value memory 311, which stores, upon receipt of a print instruction operating in the administrator mode, which includes the default values of setting items for printing set by the administrator and a notification destination when any of the default values is changed, the default values included in the print instruction and set by the administrator, and the change notification destination memory 312, which stores a notification destination, and the default value change notification unit 302, which notifies, upon receipt of a print instruction operating in the general mode, which includes the default values of setting items for printing set by a general user and the user identification information, if any of the default values set by the general user is a value changed from a corresponding one of the default values stored in the memory 31 and set by the administrator, notifies the notification destination stored in the memory 31 of the details of the change made from the default value set by the administrator and the user identification information.

The external I/F 32 communicates with the terminal 2 and other external devices through the network 5 and particularly receives a print instruction from the printer driver 201 of the terminal 2. The UI 33 includes a touchscreen, for example, and is an operation-and-display unit including an operation unit and a display.

The image output engine 34 prints image data rendered by the image rendering unit 303 using the print function unit 35. The print function unit 35 actually prints a print instruction. For example, the print function unit 35 prints document data on a recording medium such as paper using inkjet printing, and outputs the printed document data.

### Operation of Exemplary Embodiment

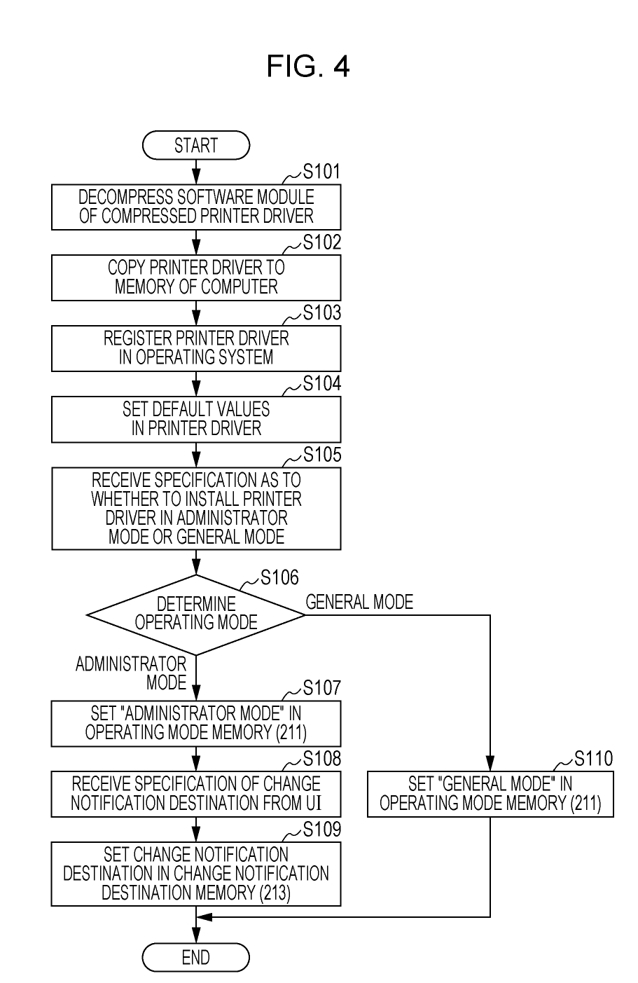

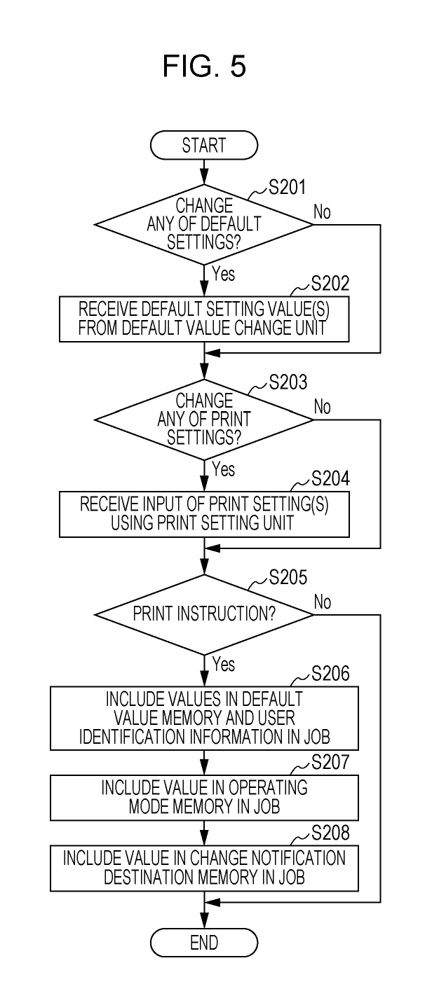

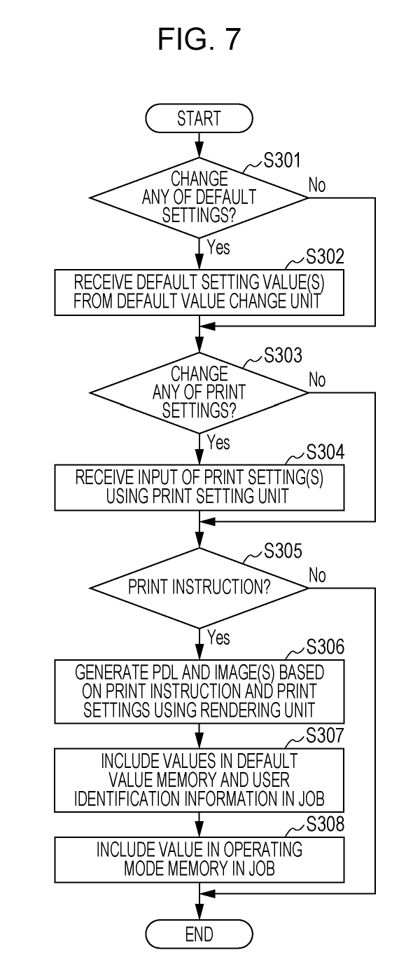

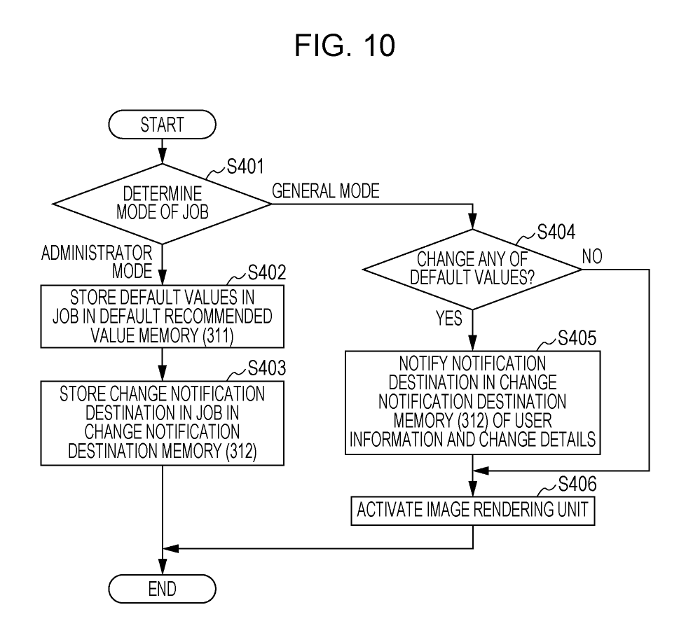

An example of the operation of the exemplary embodiment of the present invention is illustrated in the flowcharts in FIGS. 4, 5, 7, and 10. FIG. 4 is a flowchart illustrating an example of the operation of the installer according to the exemplary embodiment of the present invention. FIG. 5 is a flowchart illustrating an example of the operation in the administrator mode of the printer driver. FIG. 7 is a flowchart illustrating an example of the operation in the general mode of the printer driver. FIG. 10 is a flowchart illustrating an example of the operation of the image forming apparatus 3.

### (1) Operation of Installer

First of all, an example of the operation of the installer according to the exemplary embodiment will be described in accordance with the flowchart in FIG. 4.

The flowchart in FIG. 4 represents the operation of the installer 200 for installing the printer driver 201 on the terminal (2a, . . . , and 2d). The printer driver 201 is installed only once at the beginning on each terminal 2 (2a, . . . , and 2d) by the administrator. Hereinafter, the terminals 2a, . . . , and 2d are collectively and simply referred to as the terminal 2.

Firstly, a software module of the compressed printer driver 201 is decompressed (S101). Next, the printer driver 201 is copied to the memory 21 of the terminal 2 (S102). Next, the printer driver 201 is registered in the operating system (S103).

Next, the administrator sets default values in the printer driver 201 (S104). The set default values are stored in the default value memory 212.

Next, specification of the operating mode of the printer driver 201, input from the administrator using the UI 25, that is, specification as to whether to install the printer driver 201 in the administrator mode or the general mode, is received (S105).

Next, it is determined whether the operating mode of the printer driver 201 is the administrator mode or the general mode (S106).

When the operating mode of the printer driver 201 is the administrator mode, the “administrator mode” is set in the operating mode memory 211 (S107).

Specification of a change notification destination, specified by the administrator using the UI 25, is received (S108). The specified change notification destination is set in the change notification destination memory 213 (S109).

When the operating mode of the printer driver 201 is the general mode, the “general mode” is set in the operating mode memory 211 (S110). Accordingly, the operation of the installer 200 ends.

### (2) Operation of Printer Driver in Administrator Mode

FIG. 5 is a flowchart illustrating an example of the operation in the administrator mode of the printer driver according to the exemplary embodiment of the present invention.

At first, when the default value change unit 2014 is activated, the printer driver 201 determines whether any of the default values is to be changed (S201).

If any of the default values is to be changed (YES in S201), when the administrator enters a default setting value(s) using the UI 25 of the terminal 2, the default value change unit 2014 receives the default setting value(s) (S202).

If none of the default values is to be changed (NO in S201), nothing is performed, and the process proceeds to the next step. Next, when the print setting unit 2013 is activated, the printer driver 201 determines whether a change is to be made to any of the print settings (S203).

If any of the print settings is to be changed (YES in S203), when the administrator enters a print setting(s) using the UI 25 of the terminal 2, the print setting unit 2013 receives the changed print setting(s) (S204).

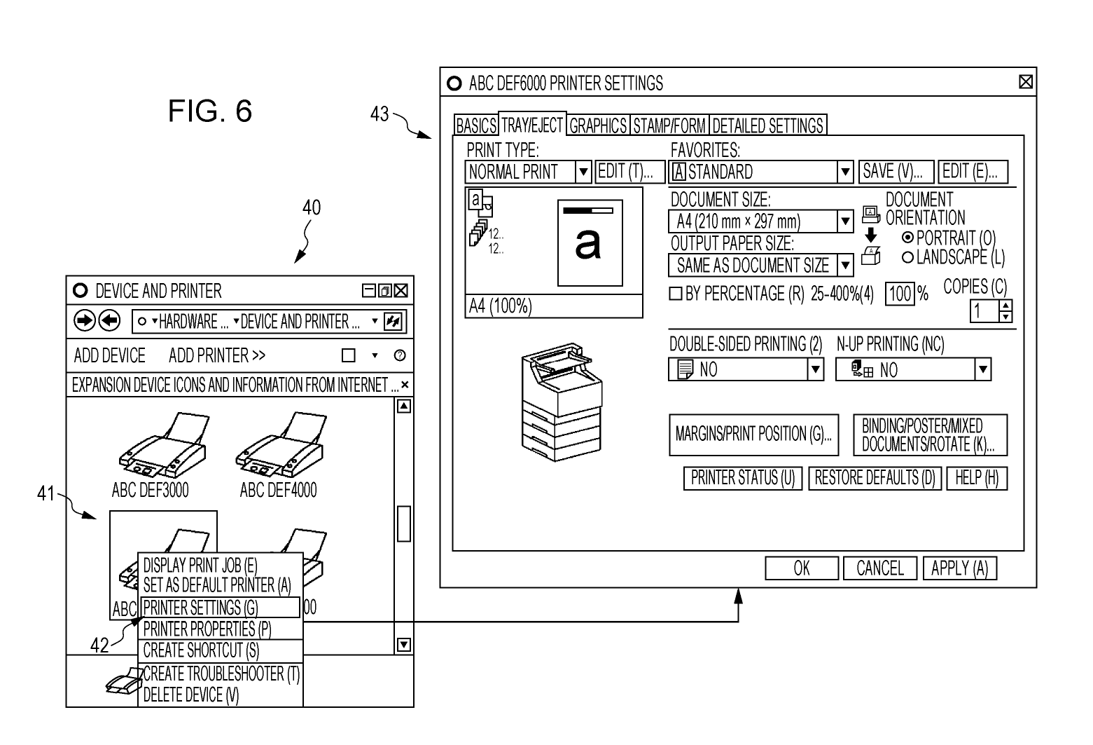

FIG. 6 illustrates an example of a display screen of the UI 25 in the case of changing one or more default values and one or more print settings. As illustrated in FIG. 6, on a screen 40 where a device and a printer are to be selected, one printer 41 is selected, and then the item print settings 42 for the printer 41 is selected. In response to this, a display screen 43 for changing one or more default values and performing the print setup is displayed. The administrator performs necessary setup on the display screen 43.

If none of the print settings is to be changed (NO in S203), nothing is performed, and the process proceeds to the next step. Next, whether there is any print instruction is determined (S205).

When there is a print instruction (YES in S205), the values in the default value memory 212 and the user identification information are included in a print job (S206). Next, the value in the operating mode memory 211 is included in the print job (S207). Furthermore, the change notification destination stored in the change notification destination memory 213 is included in the print job (S208).

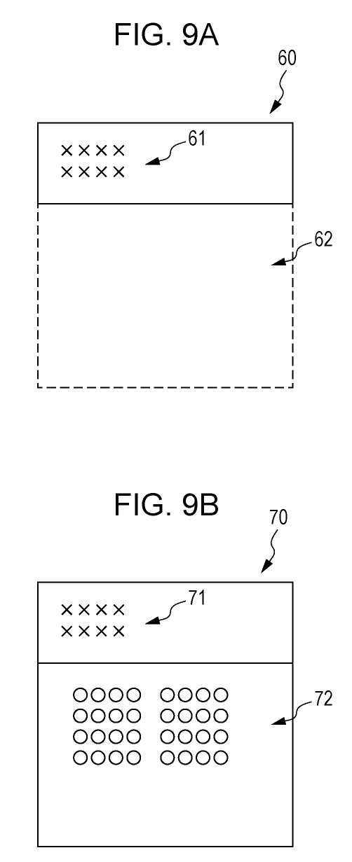

FIG. 9A illustrates an example of a print job in the case of the administrator mode. As illustrated in FIG. 9A, the above-set default values and change notification destination are included in a Printer Job Language (PJL) portion 61 of a print job 60, which controls the image forming apparatus 3, and a command for setting these items in the image forming apparatus 3 is written. Nothing is written in a PDL portion 62 below the PJL portion 61, in which no image data is usually written.

Accordingly, the default values and the change notification setting are set in the image forming apparatus 3 in the form of a print job that actually does not perform printing in the present exemplary embodiment. That is, the print job 60 in the administrator mode includes print control data, but does not include rendering data, and the default values and the change notification destination, set by the administrator, are included in the PJL portion 61.

When there is no print instruction (NO in S205), nothing is performed, and the process ends.

### (2) Operation of Printer Driver in General Mode

FIG. 7 is a flowchart illustrating an example of the operation in the general mode of the printer driver according to the exemplary embodiment of the present invention.

At first, when the default value change unit 2014 is activated, the printer driver 201 determines whether any of the default values is to be changed (S301).

If any of the default values is to be changed (YES in S301), when the user enters a default setting value using the UI 25 of the terminal 2, the default value change unit 2014 receives the default setting value (S302).

If none of the default values is to be changed (NO in S301), nothing is performed, and the process proceeds to the next step. Next, when the print setting unit 2013 is activated, the printer driver 201 determines whether a change is to be made to any of the print settings (S303).

If any of the print settings is to be changed (YES in S303), when the user enters a print setting to be changed using the UI 25 of the terminal 2, the print setting unit 2013 receives the changed print setting (S304).

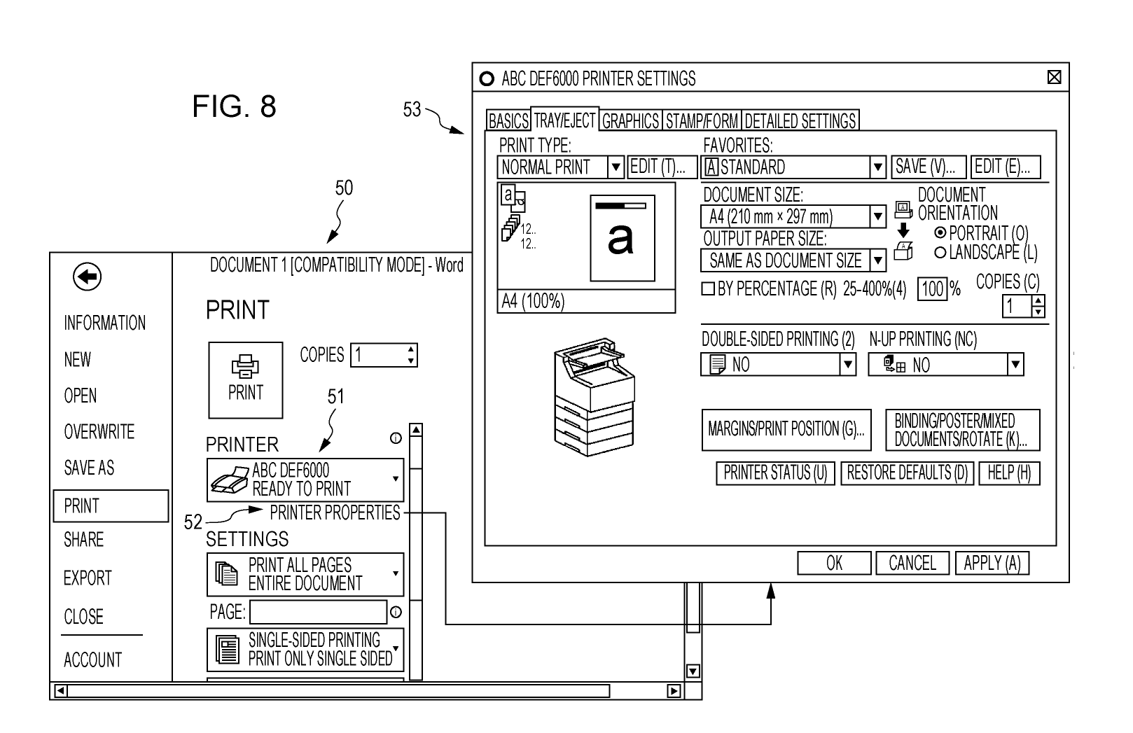

FIG. 8 illustrates an example of a display screen of the UI 25 in the case of changing one or more default values and one or more print settings. As illustrated in FIG. 8, on a print setting screen 50, one printer 51 is selected, and then the item print properties 52 for the printer 51 is selected. In response to this, a display screen 53 for changing one or more print settings is displayed. The user performs necessary setup on the display screen 53.

If none of the print settings is to be changed (NO in S303), nothing is performed, and the process proceeds to the next step. Next, whether there is any print instruction is determined (S305).

When there is a print instruction (YES in S305), the rendering unit 2011 is activated, and PDL data and one or more images are generated on the basis of the print instruction and the print settings (S306). The values in the default value memory 212 and the value in the user identification information 215 are included in a print job (S307), and furthermore the value in the operating mode memory 211 is included in the print job (S308).

FIG. 9B illustrates an example of a print job in the case of the general mode. As illustrated in FIG. 9B, data for controlling the image forming apparatus 3 is set in a PJL portion 71 of a print job 70 for controlling the image forming apparatus 3. Rendering data generated by the rendering unit 2011 is written in a PDL portion 72 below the PJL portion 71.

When there is no print instruction (NO in S305), nothing is performed, and the process ends.

### Operation of Image Forming Apparatus

FIG. 10 is a flowchart illustrating an example of the operation of the image forming apparatus according to the exemplary embodiment of the present invention.

At first, the operating mode determination unit 300 determines in which of the administrator mode and the general mode a to-be-printed print job has been output, that is, determines the mode of the print job (S401).

When the operating mode determination unit 300 determines that the mode is the administrator mode (administrator mode in S401), for example, default values set in the PJL portion 61 of FIG. 9A in the print job are stored in the default recommended value memory 311 (S402).

Next, for example, a change notification destination set in the PJL portion 61 of FIG. 9A in the print job is stored in the change notification destination memory 312 (S403). The process ends here in the case of the administrator mode. That is, no printing is actually performed in the case of the administrator mode.

When the operating mode determination unit 300 determines that the mode is the general mode (general mode in S401), next, the default value change determination unit 301 determines whether any of the default values has been changed (S404).

The default value change determination unit 301 compares the default values in the print job in the general mode with the default values stored in the default recommended value memory 311, and, if these sets of values are different, determines that one or more default values have been changed.

When it is determined that any of the default values has been changed (YES in S404), the default value change notification unit 302 notifies the change notification destination stored in the change notification destination memory 312 of the details of the change and the user information included in the print job.

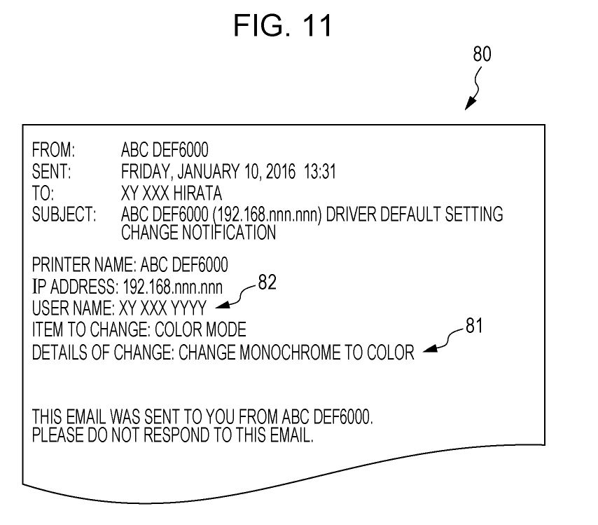

The default value change notification unit 302 notifies the change notification destination of the change via email. FIG. 11 illustrates an example of email notifying the change notification destination of the details of a change when a default value is changed.

As illustrated in FIG. 11, email 80 includes a change detail 81 that the color mode has been changed from monochrome to color, and a user name 82 indicating the user.

Thereafter or when it is determined that none of the default values has been changed (NO in S404), the image rendering unit 303 is activated, and the print job is printed through the image output engine controller 304 and the image output engine 34 (S406).

Accordingly in the present exemplary embodiment, determination done by the default value change determination unit 301 is performed by comparing the default values of print setting information included in the print job with the default recommended values set by the administrator and stored in the default recommended value memory 311. If a print job whose setting(s) of the printer driver 201 is different from the default recommended value(s) is detected at the time of printing in the image forming apparatus 3, the administrator is notified of the details of the change and the user information.

As a modification of the exemplary embodiment, multiple default recommended value memories 311 may be provided, and information indicating which set of default recommended values is to be set may be stored for each user in the default recommended value memories 311. The default value change determination unit 301 may determine whether to change any of the default values by comparing the default recommended values stored in a default recommended value memory 311 corresponding to user identification information included in a print job with the default values included in the print job.

In doing so, it becomes possible to manage multiple sets of default values and to control whether it is necessary to notify each user of a change of the default value(s) in accordance with the default recommended values.

Although the exemplary embodiment of the present invention has been described above, the present invention is not limited to the above-described embodiment, and various modifications are possible without departing from the scope of the present invention. For example, although the image forming program is stored in the memory 31 of the image forming apparatus 3 in the above-described exemplary embodiment, the image forming program may be stored in a recording medium such as a compact-disc read-only memory (CD-ROM) and provided.

Some or all of the elements of the controllers 20 and 30 may be configured by hardware circuits such as a field programmable gate array (FPGA) and an application specific integrated circuit (ASIC).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a memory that, on receipt of a print instruction operating in a first mode, the print instruction including a first setting value of a setting item for printing and a notification destination in a case where the first setting value is changed, stores the first setting value and the notification destination included in the print instruction; and
a notification unit that, on receipt of a print instruction operating in a second mode, the print instruction including a second setting value of the setting item for printing and user identification information, if the second setting value is a value that has been changed from the first setting value stored in the memory, notifies the notification destination stored in the memory of the setting item changed from the first setting value and the user identification information.

2. The image forming apparatus according to claim 1, wherein the print instruction operating in the first mode includes print control data but does not include rendering data, and the first setting value and the notification destination are included in the print control data.

3. A non-transitory computer readable medium storing a program causing a computer to execute a process, the process comprising:
on receipt of a print instruction operating in a first mode, the print instruction including a first setting value of a setting item for printing and a notification destination in a case where the first setting value is changed, storing the first setting value and the notification destination included in the print instruction; and
on receipt of a print instruction operating in a second mode, the print instruction including a second setting value of the setting item for printing and user identification information, if the second setting value is a value that has been changed from the stored first setting value, notifying the stored notification destination of the setting item changed from the first setting value and the user identification information.

4. A non-transitory computer readable medium storing a program causing a computer to execute a process, the process comprising:
setting one of a first mode and a second mode as an operating mode; and
when the operating mode is the first mode, outputting a print instruction including a first setting value of a setting item for printing and a notification destination in a case where the first setting value is changed, and, when the operating mode is the second mode, outputting a print instruction including a second setting value of the setting item for printing and user identification information.
